(19) United States
(12) Patent Application Publication
(10) Pub. No.: US 2014/0344041 A1
(43) Pub. Date: Nov. 20, 2014

(54) TRIGGERED MOBILE CHECKOUT APPLICATION

(71) Applicant: Cellco Partnership d/b/a Verizon Wireless, Basking Ridge, NJ (US)

(72) Inventor: Chandrasekhar YELESWARAPU, Walnut Creek, CA (US)

(73) Assignee: Cellco Partnership d/b/a Verizon Wireless, Basking Ridge, NJ (US)

(21) Appl. No.: 13/897,830

(22) Filed: May 20, 2013

(51) Int. Cl. G06Q 20/32; G06Q 30/02

(52) U.S. Cl. CPC G06Q 20/322; G06Q 30/0222
USPC 705/14.23

(57) ABSTRACT

A device may determine that a user device has detected an event that triggers the user device to execute a mobile checkout application associated with a retail store. The device may provide, to the user device, information that identifies a promotion associated with an item at the retail store. The device may receive, from the user device, item information that identifies the item. The device may provide, to the user device, checkout information associated with purchasing the item. The checkout information may be based on the item information and the promotion. The device may store the checkout information associated with the retail store. The device may store an association between the checkout information and other checkout information associated with the user device and another retail store.

### BACKGROUND

A barcode is an optical machine-readable representation of data relating to the object to which the barcode is attached, and may be scanned to automatically identify the object, collect data about the object, and enter data associated with the object into a computer system. Some barcodes systematically represent data using varying widths and spacings of parallel lines. A barcode or another identifier may be used to identify items in a store during the purchase process.

### BRIEF DESCRIPTION OF THE DRAWINGS

FIGS. 1A and 1B are diagrams of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for storing an indication that a user device has opted in to use a mobile checkout application;

FIG. 5 is a diagram of an example implementation relating to the example process shown in FIG. 4;

FIG. 6 is a flow chart of an example process for using a mobile checkout application;

FIGS. 7A-7E are diagrams of an example implementation relating to the example process shown in FIG. 6;

FIG. 8 is a flow chart of an example process for aggregating checkout information and providing the aggregated checkout information; and

FIG. 9 is a diagram of an example implementation relating to the example process shown in FIG. 8.

### DETAILED DESCRIPTION

The following detailed description of example implementations refers to the accompanying drawings. The same reference numbers in different drawings may identify the same or similar elements.

A user of a user device may wish to purchase an item from a retail store using a mobile checkout application installed on the user device. The user may also wish to receive coupons and/or offers associated with one or more retail stores via the mobile checkout application. The user may also want to store information associated with purchases made using the mobile checkout application. Additionally, the one or more retail stores and/or the service provider associated with the user device may wish to access information associated with the user's purchases. Implementations described herein may allow a user to purchase items from a variety of retail stores using a single mobile checkout application, may store purchase information for future review, and may allow one or more retail stores and/or a service provider to access information associated with the user's purchases.

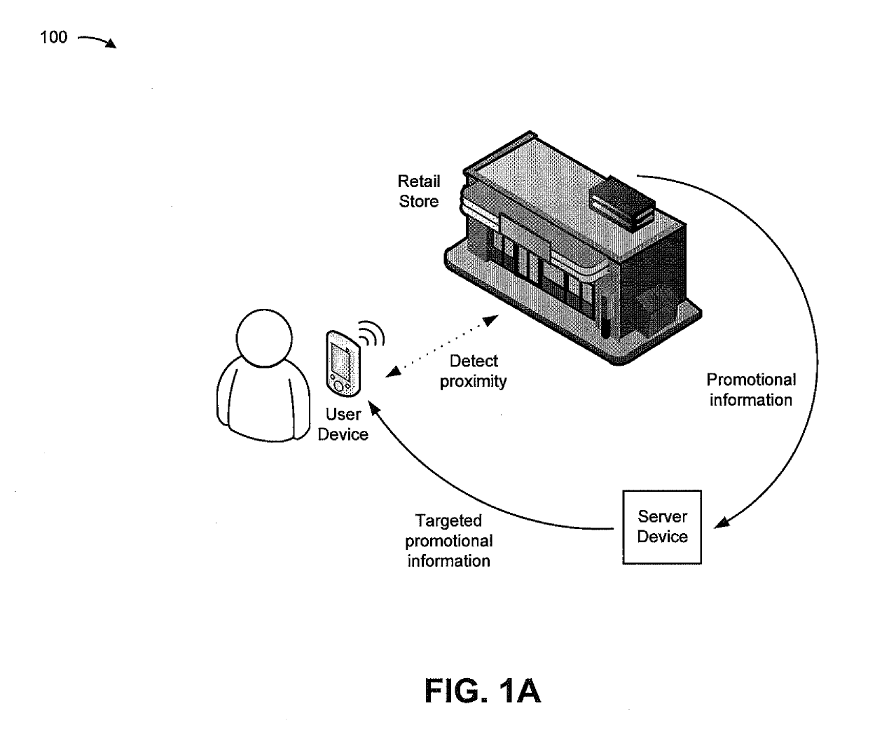

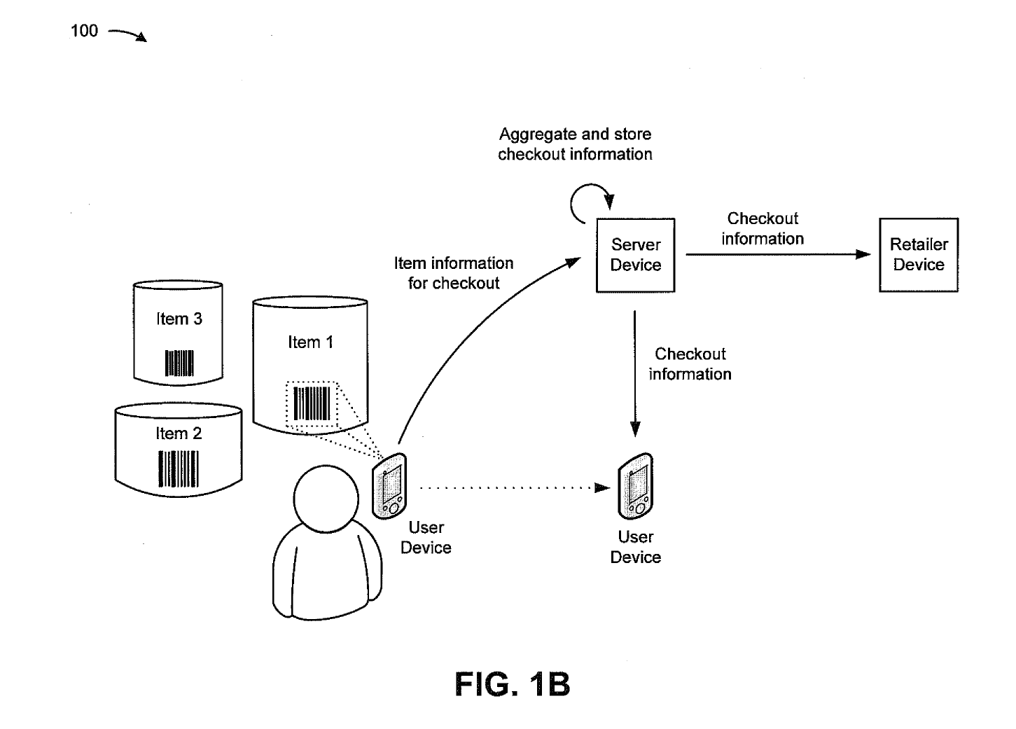

FIGS. 1A and 1B are diagrams of an overview of an example implementation 100 described herein. As shown in FIG. 1A, assume that a user of a user device is entering a retail store. Further, assume that there is a mobile checkout application, associated with the service provider of the user device, installed on the user device. Finally, assume that the retail store has an agreement with the service provider that allows the user to purchase items from the retail store using the mobile checkout application installed on the user device.

As shown in FIG. 1A, the user device may detect that the user is near the retail store. The user device may run the mobile checkout application based on detecting that the user is near the retail store. As further shown, a retailer device associated with the retail store may provide promotional information, associated with the retail store, to a server device associated with the service provider of the user device. The server device may store information associated with the user of the user device and/or information associated with a previous purchase made using the mobile checkout application. The server device may communicate with the retailer device to determine targeted promotional information to provide to the user device. The targeted promotional information may be based on the promotional information, the information associated with the user, and/or the information associated with the previous purchase. As further shown in FIG. 1A, the server device may provide the targeted promotional information to the user device, and the user device may display the targeted promotional information.

As shown in FIG. 1B, assume that the user of the user device has entered the retail store and has decided to purchase an item using the mobile checkout application. As shown, the user device may determine item information associated with the item (e.g., by scanning a barcode). As further shown in FIG. 1B, assume that the user chooses to complete the purchase of the scanned item. The user device may provide the item information to the server device associated with the service provider. The server device may determine checkout information (e.g., complete the purchase of the item, etc.). As further shown in FIG. 1B, the server device may provide the checkout information to the user device to indicate that the purchase is complete. The server device may also provide the checkout information to a retailer device for use by the retail store (e.g., to confirm payment, to disable security tags, to track inventory, etc.).

As further shown in FIG. 1B, the server device may aggregate and store checkout information associated with the user device and one or more retail stores. The server device may allow the user to view the aggregated information and/or may provide the aggregated information to one or more devices associated with one or more retail stores. In this way, a user of a user device may purchase items from one or more retail stores using a mobile checkout application and the information associated with the purchases may be stored by a server device associated with the mobile checkout application.

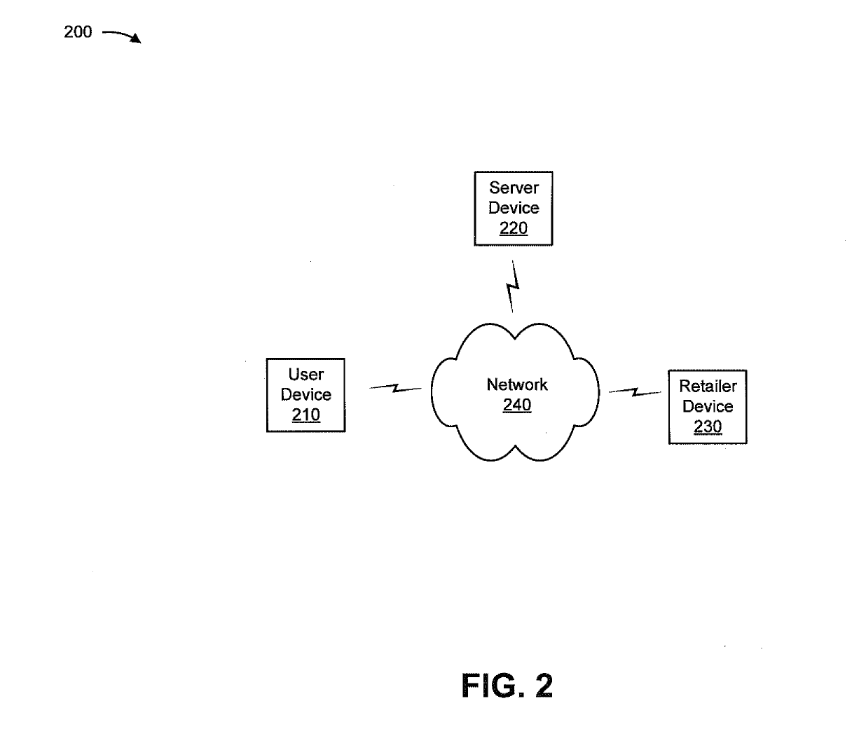

FIG. 2 is a diagram of an example environment 200 in which systems and/or methods described herein may be implemented. As shown in FIG. 2, environment 200 may include a user device 210, a server device 220, a retailer device 230, and a network 240.

User device 210 may include a device capable of communicating with network 240. For example, user device 210 may include a wireless communication device, a radiotelephone, a personal communications system (“PCS”) terminal (e.g., that may combine a cellular radiotelephone with data processing and data communications capabilities), a personal digital assistant (“PDA”) (e.g., that can include a radiotelephone, a pager, Internet/intranet access, etc.), a smart phone, a laptop computer, a tablet computer, and/or a similar device. In some implementations, user device 210 may be capable of running a mobile checkout application, associated with a service provider of user device 210, installed on user device 210. User device 210 may also be capable of detecting a trigger associated with the mobile checkout application (e.g., by detecting global positioning system (“GPS”) coordinates, by detecting a wireless local area network associated with a retail store, etc.). In some implementations, user device 210 may be capable of determining information associated with an item that is to be purchased from a retail store using the mobile checkout application (e.g., by scanning a barcode, by reading a near field communication (“NFC”) tag, etc.). In some implementations, user device 210 may receive information associated with the mobile checkout application from server device 220 (e.g., an update associated with the mobile checkout application, information associated with a particular retail store used to customize the mobile checkout application for the particular retail store, etc.).

Server device 220 may include a device capable of receiving, generating, processing, storing, and/or providing information associated with a mobile checkout application. For example, server device 220 may include a server, a computing device, or the like. In some implementations, server device 220 may receive, store, and/or provide information associated with a purchase of an item from a retail store. In some implementations, server device 220 may communicate with retailer device 230 to determine content (e.g., targeted promotional information, etc.) to be provided to user device 210. Additionally, or alternatively, server device 220 may aggregate and store checkout information associated with user device 210 and one or more retail stores, and may provide the aggregated checkout information to another device (e.g., user device 210, retailer device 230, etc.).

Retailer device 230 may include a device capable of receiving, generating, processing, storing, and/or providing information associated with a mobile checkout application. For example, retailer device 230 may include a server, a computing device, or a similar device. In some implementations, retailer device 230 may receive, store, and/or provide information associated with a purchase of an item from the retail store associated with retailer device 230. In some implementations, retailer device 230 may receive, store, and/or provide promotional information associated with a retail store (e.g., information associated with an advertising campaign, a targeted promotional campaign, etc.). In some implementations, retailer device 230 may receive checkout information (e.g., a purchase confirmation, item information, security information, etc.) associated with the purchase of an item and/or may receive aggregated checkout information associated with user device 210 and one or more retail stores.

Network 240 may include one or more wired and/or wireless networks. For example, network 240 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

The number of devices and/or networks shown in FIG. 2 is provided for explanatory purposes. In practice, there may be additional devices and/or networks, fewer devices and/or networks, different devices and/or networks, or differently arranged devices and/or networks than those shown in FIG. 2. Furthermore, two or more of the devices shown in FIG. 2 may be implemented within a single device, or a single device shown in FIG. 2 may be implemented as multiple, distributed devices. Additionally, one or more of the devices of environment 200 may perform one or more functions described as being performed by another one or more of the devices of environment 200. Devices of environment 200 may interconnect via wired connections, wireless connections, or a combination of wired and wireless connections.

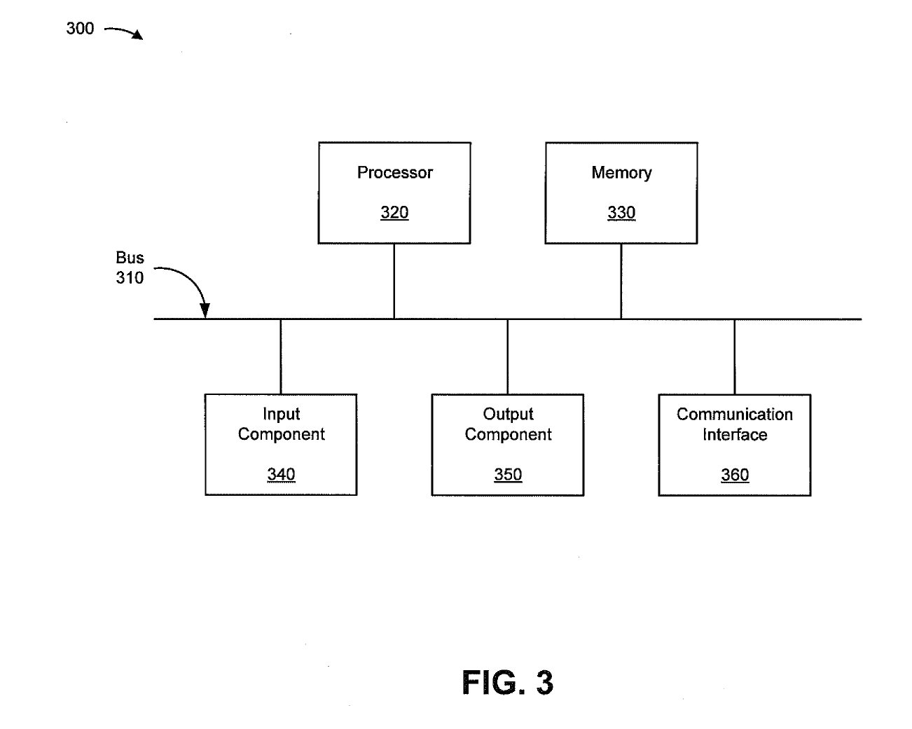

FIG. 3 is a diagram of example components of a device 300. Device 300 may correspond to user device 210, server device 220, and/or retailer device 230. Additionally, or alternatively, each of user device 210, server device 220, and/or retailer device 230 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor, a microprocessor, and/or any processing component (e.g., a field-programmable gate array (“FPGA”), an application-specific integrated circuit (“ASIC”), etc.) that interprets and/or executes instructions. In some implementations, processor 320 may include one or more processor cores. Memory 330 may include a random access memory (“RAM”), a read only memory (“ROM”), and/or any type of dynamic or static storage device (e.g., a flash memory, a magnetic memory, an optical memory, etc.) that stores information and/or instructions for use by processor 320.

Input component 340 may include any component that permits a user to input information to device 300 (e.g., a keyboard, a keypad, a mouse, a button, a switch, etc.). Output component 350 may include any component that outputs information from device 300 (e.g., a display, a speaker, one or more light-emitting diodes (“LEDs”), etc.).

Communication interface 360 may include any transceiver-like component, such as a transceiver and/or a separate receiver and transmitter, that enables device 300 to communicate with other devices and/or systems, such as via a wired connection, a wireless connection, or a combination of wired and wireless connections. For example, communication interface 360 may include a component for communicating with another device and/or system via a network. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes that are described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

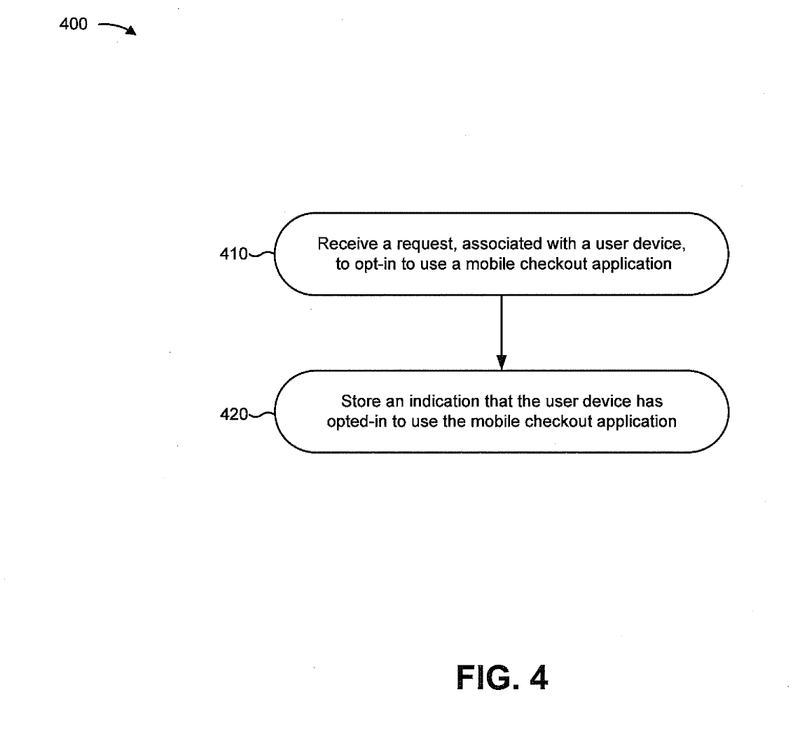

FIG. 4 is a flow chart of an example process 400 for storing an indication that a user device has opted in to use a mobile checkout application. In some implementations, one or more process blocks of FIG. 4 may be performed by server device 220. In some implementations, one or more process blocks of FIG. 4 may be performed by another device or a group of devices separate from or including server device 220, such as user device 210 and/or retailer device 230.

As shown in FIG. 4, process 400 may include receiving a request, associated with a user device, to opt in to use a mobile checkout application (block 410). For example, server device 220 may receive a request to opt in to use a mobile checkout application. In some implementations, server device 220 may receive the request from user device 210.

In some implementations, a user may input information associated with the request into user device 210, and user device 210 may transmit the information and the request to server device 220. For example, the user of user device 210 may input information associated with the request via a user interface, provided by the mobile checkout application, displayed on user device 210. The information input by the user may include a user device identifier that identifies user device 210, a request to opt in (e.g., to use the mobile checkout application) or opt out (e.g., to not use the mobile checkout application), or the like. The information and the request may be sent from user device 210 to server device 220.

A mobile checkout application, as used herein, may refer to an application, installed on and/or accessible by user device 210, that may allow a user of user device 210 to purchase an item from a retail store using user device 210. In some implementations, the mobile checkout application may allow the user to purchase items, using user device 210, from one or more retail stores. Additionally, or alternatively, the mobile checkout application may be associated with a service provider that provides network services to user device 210.

As further shown in FIG. 4, process 400 may include storing an indication that the user device has opted in to use the mobile checkout application (block 420). For example, server device 220 may store the indication in a data structure. The indication may identify whether user device 210 has opted in or opted out of using the mobile checkout application. In some implementations, server device 220 may store information associated with the indication, such as a user device identifier (e.g., an international mobile subscriber identity (“IMSI”), a mobile subscriber integrated services digital network-number (“MSISDN”), a mobile directory number (“MDN”), etc.) of user device 210 that has opted in or opted out. Additionally, or alternatively, server device 220 may store information associated with the indication, such as a user identifier that may be required to access the mobile checkout application (e.g., a username, a password, etc.)

While a series of blocks has been described with regard to FIG. 4, the blocks and/or the order of the blocks may be modified in some implementations. Additionally, or alternatively, non-dependent blocks may be performed in parallel. Further, one or more blocks may be omitted.

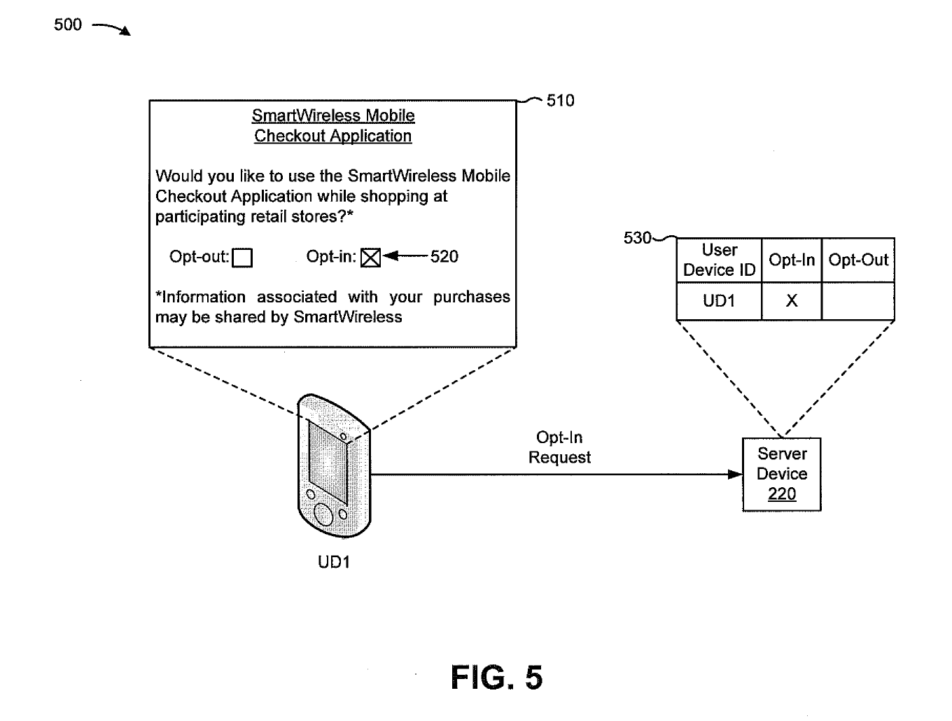

FIG. 5 is a diagram of an example implementation 500 relating to example process 400 shown in FIG. 4. In example implementation 500, assume that server device 220 receives a request, from user device UD1, to opt in to use a SmartWireless mobile checkout application and stores an indication of the request in a data structure.

As shown in FIG. 5, a user may interact with a user preferences interface 510, provided on a display of user device UD1, to configure a request to opt in to use the SmartWireless mobile checkout application. For example, a user may interact (e.g., by touching, by clicking, etc.) with an input element (e.g., a checkbox, etc.) on user interface 510, as shown by reference number 520, to configure a request for user device UD1 to opt in to use the SmartWireless mobile checkout application. User device UD1 may send the opt in request to server device 220, as shown.

As further shown in FIG. 5, server device 220 may receive the request to opt in to use the SmartWireless mobile checkout application from user device UD1. As shown by reference number 530, server device 220 may store an indication that user device UD1 is opted in to use the mobile checkout application.

As indicated above, FIG. 5 is provided merely as an example. Other examples are possible and may differ from what was described with regard to FIG. 5.

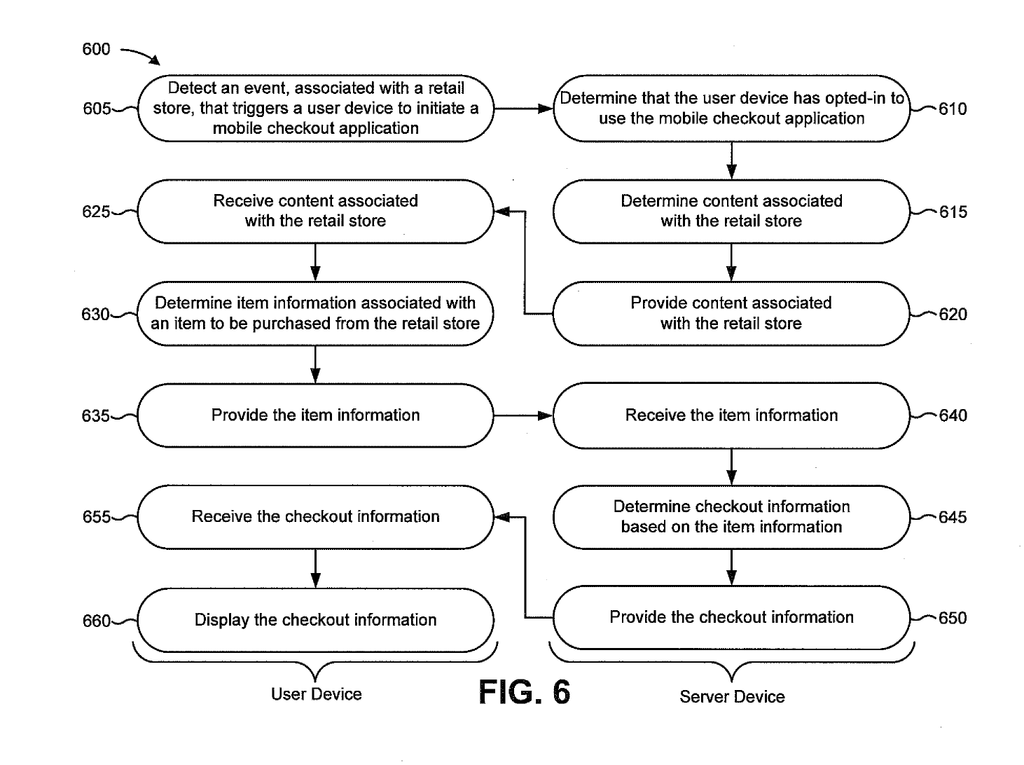

FIG. 6 is a flow chart of an example process 600 for using a mobile checkout application. In some implementations, one or more process blocks of FIG. 6 may be performed by user device 210 and/or server device 220. In some implementations, one or more process blocks of FIG. 6 may be performed by another device or group of devices separate from or including user device 210 and/or server device 220, such as retailer device 230.

As shown in FIG. 6, process 600 may include detecting an event, associated with a retail store, that triggers a user device to initiate a mobile checkout application (block 605). For example, user device 210 may detect the event that triggers user device 210 to start up a mobile checkout application installed on and/or accessible by user device 210.

In some implementations, user device 210 may run the mobile application based on detecting an event associated with a location of user device 210 (e.g., by detecting that user device 210 is near a retail store based on a set of known GPS coordinates associated with the retail store and a received signal strength indication, etc.). Additionally, or alternatively, user device 210 may run the mobile application based on detecting information associated with a retail store (e.g., by detecting a service set identifier (“SSID”) of a wireless network associated with the retail store, etc.).

In some implementations, user device 210 may run the mobile checkout application based on detecting an event associated with input from a user of user device 210. For example, user device 210 may run the mobile checkout application based on input, provided by the user of user device 210, indicating that user device 210 is to run the mobile checkout application (e.g., the user may select an icon associated with the mobile checkout application displayed on a display screen of user device 210). In some implementations, user device 210 may determine and store information identifying the location of user device 210 (e.g., GPS coordinates, etc.) when user device 210 runs the mobile checkout application. The stored location information may be used to automatically trigger user device 210 to run the mobile checkout application in the future. In some implementations, user device 210 may communicate with server device 220 based on running the mobile checkout application.

In some implementations, the mobile checkout application may be customized and/or may change based on a location (e.g., a retail store) of user device 210 (e.g., retailer device 230 may provide information to server device 220 that may allow the mobile checkout application to be to customized based on the retail store and/or a location detected by user device 210, etc.).

In some implementations, the mobile checkout application may be scalable to allow for the addition of a retail store that may choose to be associated with the mobile checkout application (e.g., the mobile checkout application can be updated over-the-air by the service provider when a retail store enters an agreement with the service provider to allow use of the mobile checkout application to purchase items from the retail store, etc.).

As further shown in FIG. 6, process 600 may include determining that the user device has opted in to use the mobile checkout application (block 610). For example, server device 220 may determine that user device 210 has opted in to use the mobile checkout application. In some implementations, server device 220 may determine that user device 210 has opted in to use the mobile checkout application based on information associated with user device 210. For example, server device 220 may determine that user device 210 has opted in to use the mobile checkout application based on information associated with an opt in request, received from user device 210 and stored by server device 220 (e.g., in a data structure associated with server device 220).

In some implementations, server device 220 may determine that user device 210 has opted in to use the mobile checkout application based on input, provided by a user of user device 210, indicating that user device 210 has opted in to use the mobile checkout application. For example, upon running the mobile checkout application, user device 210 may prompt a user to choose to opt in to using the mobile checkout application (e.g., when the mobile checkout application runs for the first time, when the mobile checkout application has not previously been used at the particular retail store that user device 210 is near or in, etc.). In some implementations, user device 210 may opt in to use the mobile checkout application for a specified period of time (e.g., a one-time use, a 30 day trial period, a six month trial period, etc.), and the user of user device 210 may choose to opt in or opt out of using the mobile checkout application upon the expiration of the period of time. Additionally, or alternatively, user device 210 may opt in to use (or opt out of using) the mobile checkout application at a particular retail store. In other words, the user may specify a preference to use the mobile checkout application for a first retail store, but not for a second retail store.

As further shown in FIG. 6, process 600 may include determining content associated with the retail store (block 615). For example, server device 220 may determine content associated with the retail store based on information stored by server device 220 and/or information received from retailer device 230.

In some implementations, server device 220 may communicate with retailer device 230 to determine the content associated with the retail store. For example, server device 220 may provide information associated with a user of user device 210 (e.g., an age of the user, a gender of the user, other demographic information of the user, etc.) and/or information associated with user device 210 (e.g., information associated with a previous purchase made using the mobile checkout application, etc.) to retailer device 230. Additionally, or alternatively, server device 220 may provide a segment identifier to retailer device 230. The segment identifier may include a string of characters (e.g., a string of numbers, etc.) that may be associated with the user of user device 210 and/or other information associated with user device 210. In some implementations, the segment identifier may identify demographic information associated with the user (e.g., a number associated with a gender, a number associated with an age group, etc.), may identify past purchases (e.g., a number associated with a purchased product, a number associated with a purchased brand of product, etc.), or the like.

In some implementations, retailer device 230 may receive the information from server device 220, and may determine content to be provided to user device 210 based on the information received from server device 220 (e.g., by identifying a coupon based on the demographic information, the previous purchase information, the segment identifier, etc.). Additionally, or alternatively, the content to be provided to user device 210 may be based on information stored by retailer device 230 (e.g., an advertising campaign associated with the retail store, a discount currently offered by the retail store, etc.). In some implementations, retailer device 230 may provide the content to server device 220, and server device 220 may determine the content associated with the retail store based on the content received from retailer device 230.

Content associated with the retail store, as used herein, may include information associated with the retail store and/or targeted promotional information associated with the retail store. In some implementations, the content may include information used to customize the mobile checkout application. For example, the content may include information associated with the retail store and may be used to customize a user interface of the mobile checkout application displayed on user device 210 (e.g., by displaying a logo of the particular retail store, by displaying a color scheme associated with the particular retail store, etc.).

In some implementations, the content may be targeted toward a user of user device 210 based on information stored by retailer device 230 and/or information stored by server device 220. For example, the content may be targeted toward a user of user device 210 based on information associated with the user (e.g., demographic information, a user profile, etc.), information associated with items purchased using user device 210 (e.g., a category of item purchased, a previous item purchased, etc.), information associated with the retail store (e.g., an advertising campaign, etc.), or the like. In some implementations, the content associated with the retail store may include information associated with a cost of an item sold by the retail store that may be associated with user device 210 (e.g., a coupon for an item that the user of user device 210 has purchased in the past, etc.). In some implementations, the content may be based on a predictive analysis, performed by server device 220, that may be based on previous purchases made at one or more retail stores (e.g., determining a behavioral pattern based on the user's purchases at multiple retail stores). In some implementations, the retail stores may be unaffiliated with each other (e.g., not part of the same chain of retail stores, not affiliated with a common parent company, etc.).

As further shown in FIG. 6, process 600 may include providing the content associated with the retail store (block 620). For example, server device 220 may provide the content, associated with the retail store, to user device 210. In some implementations, server device 220 may provide the content associated with the retail store to user device 210 based on determining the content associated with the retail store, based on receiving an indication that user device 210 has detected an event that triggers user device 210 to run the mobile checkout application, and/or based on receiving an indication that user device 210 has launched or is running the mobile checkout application.

As further shown in FIG. 6, process 600 may include receiving the content associated with the retail store (block 625). For example, user device 210 may receive the content, associated with the retail store, from server device 220. In some implementations, user device 210 may display information associated with the content on a display screen of user device 210 (e.g., via a user interface of the mobile checkout application). In some implementations, the displayed content may include information associated with an item in the retail store (e.g., an available discount, a special offer, a list of items on sale, etc.). In some implementations, the content may be stored in a memory location, associated with the mobile checkout application, of user device 210, and may be deleted from user device 210 when the user of user device 210 leaves the retail store.

As further shown in FIG. 6, process 600 may include determining item information associated with an item to be purchased from the retail store (block 630). For example, user device 210 may determine item information associated with an item to be purchased from the retail store associated with retailer device 230. In some implementations, user device 210 may determine the item information based on detecting information associated with the item (e.g., by scanning a barcode, by reading an NFC tag, by scanning a quick response (“QR”) code, etc.). Additionally, or alternatively, user device 210 may determine the item information based on input provided by a user of user device 210 via a user interface of the mobile checkout application (e.g., a product code, a product name, a photo of the item, etc.). In some implementations, the item information may include information indicating whether the item may be purchased by the user of user device 210. For example, server device 220 may determine whether a regulated item (e.g., tobacco, alcohol, etc.) may be purchased by a user of user device 210 (e.g., based on demographic information, associated with the user, stored by server device 220).

Item information, as used herein, may include information associated with an item available from a retail store. For example, item information may include information identifying the item (e.g., a name of the item, a brand of the item, etc.), information identifying an attribute of the item (e.g., a size of the item, a serial number of the item, etc.), information identifying a category of the item (e.g., a food category, a clothing category, a regulated category, etc.), information identifying a cost of the item (e.g., a retail cost of the item, a discounted cost of the item based on the content associated with the retail store, etc.), or the like. In some implementations, the item information may include a discount associated with the item, and the discount may be automatically applied when the item is scanned (e.g., using a barcode, using an NFC tag, etc.).

In some implementations, the display screen of user device 210 may display item information associated with one or more items (e.g., a list of items, etc.). Additionally, or alternatively, the display screen of user device 210 may display information associated with a cost of the one or more items (e.g., a total cost of the one or more items, a total discount applied to the cost of the one or more items, etc.).

As further shown in FIG. 6, process 600 may include providing the item information (block 635). For example, user device 210 may provide the item information to server device 220. In some implementations, user device 210 may provide the item information to server device 220 based on input provided by the user of user device 210. For example, the user of user device 210 may provide input, via an input element displayed on a display screen of user device 210, indicating that the user wishes to complete the purchase of one or more items (e.g. by clicking a “checkout” button, by clicking a “finish” button, etc.), and user device 210 may provide the item information, associated with the item, to server device 220.

In some implementations, user device 210 may provide the item information to server device 220 when user device 210 determines the item information. For example, user device 210 may determine the item information associated with the item, and user device 210 may provide the item information to server device 220 (e.g., the item information may be provided to server device 220 without additional input from the user).

As further shown in FIG. 6, process 600 may include receiving the item information (block 640). For example, server device 220 may receive the item information from user device 210. In some implementations, server device 220 may receive the item information based on user device 210 providing the item information to server device 220.

As further shown in FIG. 6, process 600 may include determining checkout information based on the item information (block 645). For example, server device 220 may determine checkout information based on the item information received from user device 210.

In some implementations, server device 220 may determine checkout information based on a method of payment associated with user device 210. For example, a method of payment (e.g., a credit card, a mobile wallet account, etc.), associated with user device 210, may be stored by server device 220. In some implementations, server device 220 may complete a payment for the item based on the method of payment stored on server device 220 (e.g., by communicating with retailer device 230 and/or user device 210, by communicating with a mobile wallet device, etc.), and server device 220 may determine the checkout information, associated with the item, based on completing the payment.

Checkout information, as used herein, may include information indicating that a payment for the item, associated with the item information, has been received (e.g., a payment confirmation, etc.). In some implementations, the checkout information may include security information associated with the item (e.g., information indicating that security tags associated with the item are to be deactivated, etc.), may include the item information (e.g., the name of the item, the cost of the item, etc.), and/or may include a confirmation code associated with the purchase of the item (e.g., a confirmation number, etc.).

In some implementations, server device 220 may store the checkout information. In some implementations, the checkout information may be stored for future viewing by the user of user device 210. Additionally, or alternatively, the checkout information may be stored by server device 220 for aggregation by server device 220.

As further shown in FIG. 6, process 600 may include providing the checkout information (block 650). For example, server device 220 may provide the checkout information to retailer device 230. In some implementations, server device 220 may provide the checkout information to retailer device 230 to indicate that the purchase of the item is complete. Additionally, or alternatively, server device 220 may provide the checkout information to retailer device 230 to indicate that security devices (e.g., security tags, etc.) are to be disabled for purchased items. Additionally, or alternatively, server device 220 may provided the checkout information to retailer device 230 to indicate that security gates are to allow a purchased item to pass through without raising an alarm (e.g., by providing NFC tag identifiers associated with purchased items to security gates, etc.). Additionally, or alternatively, server device 220 may provide the checkout information to a security tag (e.g., an NFC tag) attached to a purchased item to disable the tag from alerting a security device associated with the retail store. Additionally, or alternatively, server device 220 may provide the checkout information to user device 220, and user device 220 may provide the checkout information to a security tag (e.g., an NFC tag) associated with a purchased item to disable the tag. Additionally, or alternatively, server device 220 may provide the checkout information to retailer device 230 for a business purpose associated with the retail store (e.g., to track inventory, etc.).

In some implementations, server device 220 may provide the checkout information to user device 210. For example, server device 220 may provide the checkout information to user device 210 to indicate to the user of user device 210 that payment for the item has been completed. Additionally, or alternatively, server device 220 may provide the checkout information to user device 210 to allow the user of user device 210 to view a receipt associated with the checkout information. Additionally, or alternatively, server device 220 may detect a threshold associated with inventory of an item and may notify retailer device 230 (e.g., a threshold indicating that inventory of the item should be replenished, etc.).

As further shown in FIG. 6, process 600 may include receiving the checkout information (block 655). For example, user device 210 may receive the checkout information from server device 220. In some implementations, user device 210 may receive the checkout information from server device 220 based on server device 220 providing the checkout information to user device 210.

As further shown in FIG. 6, process 600 may include displaying the checkout information (block 660). For example, user device 210 may display the checkout information, received from server device 220, associated with the item. In some implementations, user device 210 may display the checkout information indicating that payment for the item has been complete. Additionally, or alternatively, user device 210 may display the checkout information associated with the payment (e.g., a receipt, a total cost, a quantity of items, a confirmation number, etc.) Additionally, or alternatively, user device 210 may display the checkout information indicating that the checkout information has been stored by server device 220 for future review by the user (e.g., a notification that the user of user device 210 can access a receipt for the item stored by server device 220). In some implementations, the user of user device 210 may be required to provide the checkout information before exiting the retail store (e.g., by printing a receipt associated with the purchase, by providing a confirmation code to an employee of the retail store or a device associated with the retail store, etc.).

While a series of blocks has been described with regard to FIG. 6, the blocks and/or the order of the blocks may be modified in some implementations. Additionally, or alternatively, non-dependent blocks may be performed in parallel. Further, one or more blocks may be omitted.

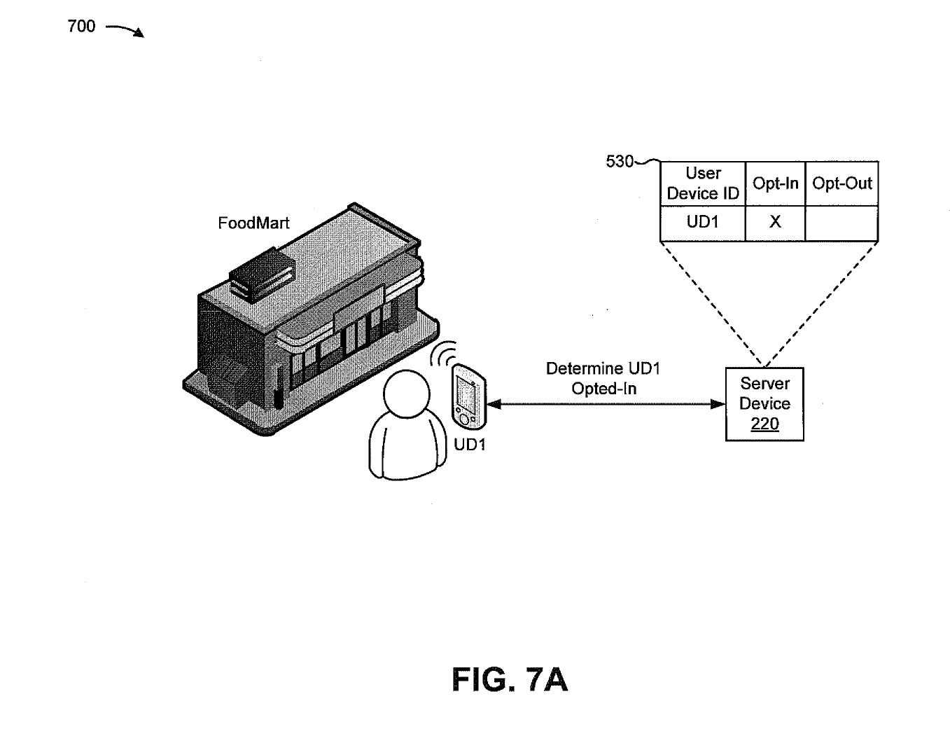

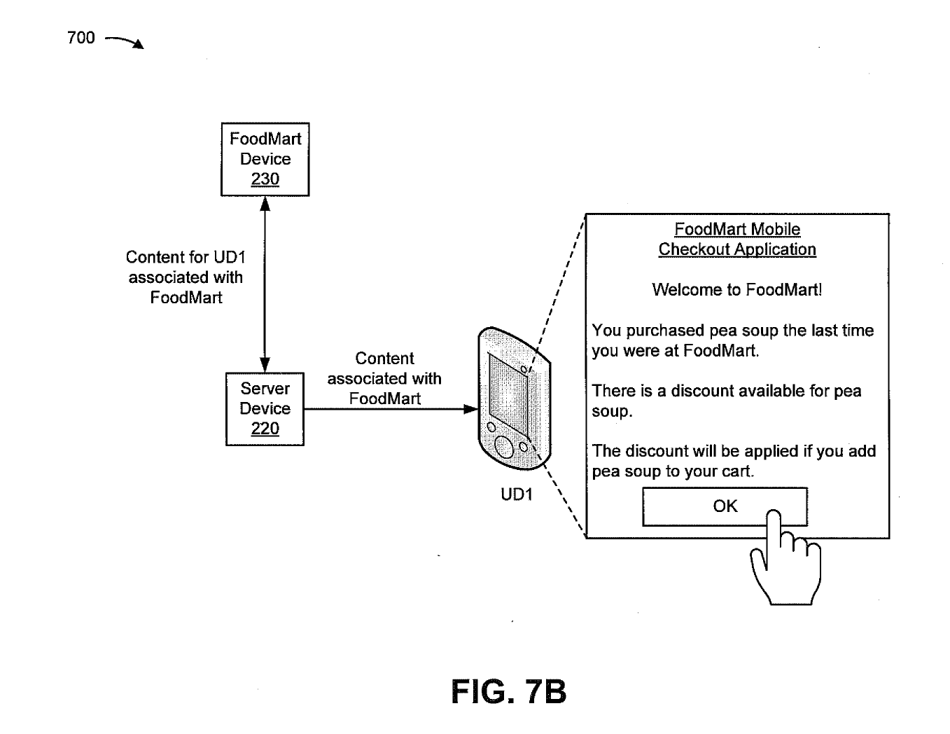

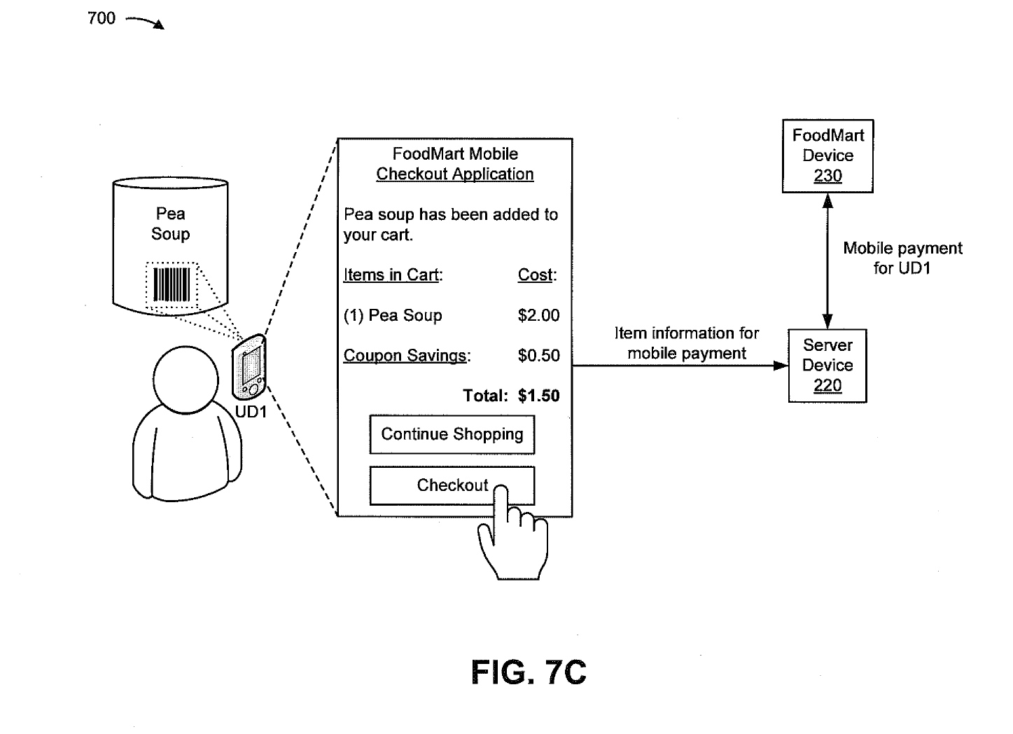

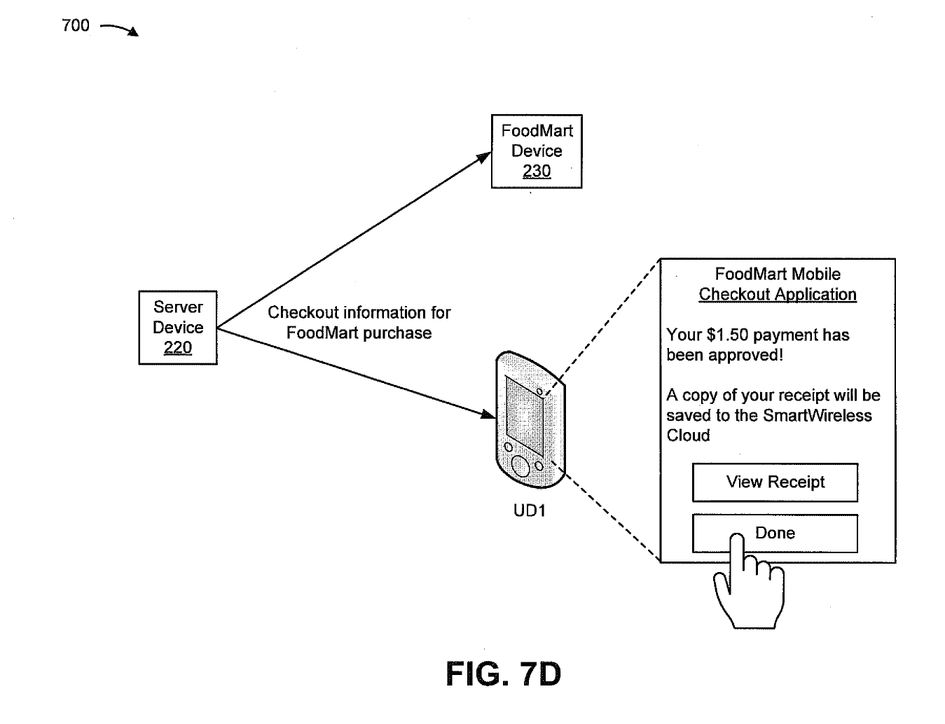

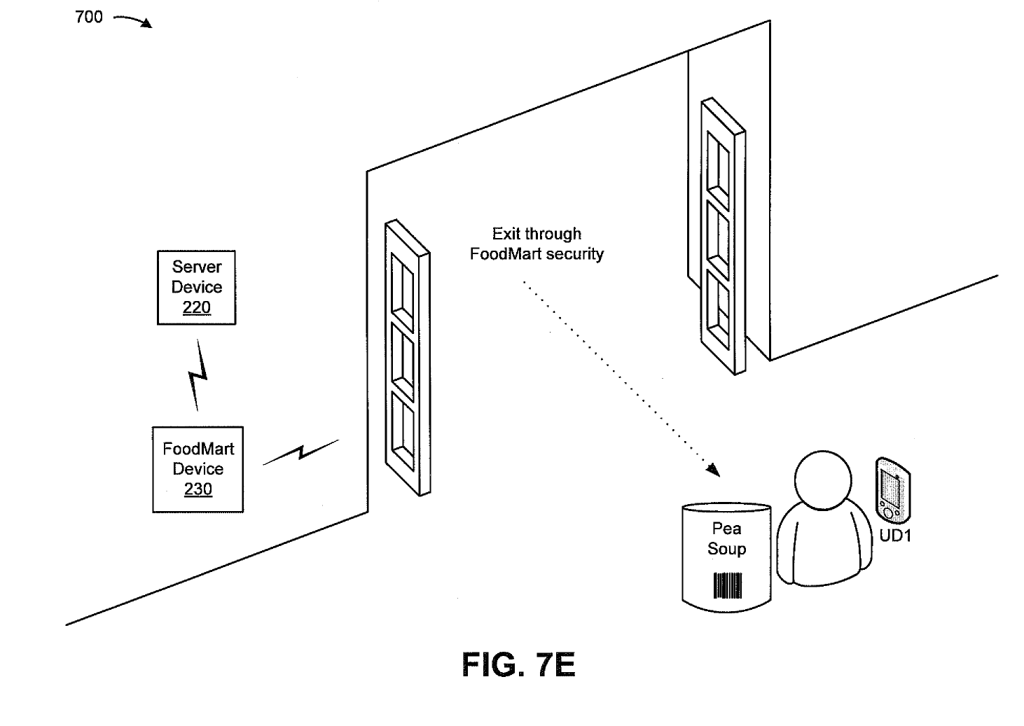

FIGS. 7A-7E are diagrams of an example implementation 700 relating to example process 600 shown in FIG. 6. For the purpose of example implementation 700, assume that a user of user device UD1 is entering FoodMart, a retail store. Further, assume that FoodMart has an agreement with a SmartWireless service provider that allows a customer of FoodMart to purchase items using a SmartWireless mobile checkout application, and assume that a set of GPS coordinates associated with FoodMart is incorporated into the SmartWireless mobile checkout application. Finally, assume that the user of user device UD1 has previously requested to opt in to use a SmartWireless mobile checkout application, and that the user of user device UD1 has previously purchased an item from FoodMart using the mobile checkout application.

As shown in FIG. 7A, user device UD1 may detect that the user is near FoodMart. For example, user device UD1 may determine a set of GPS coordinates corresponding to the location of user device UD1, and may compare the set of GPS coordinates to a set of known GPS coordinates, associated with FoodMart, incorporated into the SmartWireless mobile checkout application. User device UD1 may determine that the user is near Foodmart based on comparing the two sets of GPS coordinates.

As further shown in FIG. 7A, server device 220 may determine that user device UD1 has opted in to use the SmartWireless mobile checkout application. For example, server device 220 may determine that user device UD1 has opted in to use the SmartWireless mobile checkout application when user device UD1 detects that user device UD1 is near FoodMart and runs the SmartWireless mobile checkout application. The determination may be based on information, associated with user device UD1, stored in data structure 530, as shown.

As shown in FIG. 7B, server device 220 may determine content, associated with FoodMart, that may be provided to user device UD1, and that may be displayed on a display screen of user device UD1 via the SmartWireless mobile checkout application. For example, server device 220 may communicate with FoodMart device 230 to determine content associated with FoodMart based on a previous purchase made by the user of user device UD1 and/or based on content stored by FoodMart device 230. As shown, server device 220 may determine that user device UD1 was used to purchase a can of pea soup from FoodMart (e.g., based on information stored by server device 220), and may determine that there is a discount on pea soup at FoodMart (e.g., based on information received from FoodMart device 230).

As further shown in FIG. 7B, server device 220 may provide the content associated with the discount on pea soup to user device UD1. As further shown, user device UD1 may display the content associated with the discount on pea soup on a display screen of user device UD1. For example, user device UD1 may display the content indicating that the user purchased pea soup the last time the user was at FoodMart, that there is a discount on pea soup currently available at FoodMart, and that the discount will be automatically applied if the user of user device UD1 elects to purchase pea soup, as shown.

As shown in FIG. 7C, assume that the user of user device UD1 wishes to purchase a can of pea soup. User device UD1 may determine item information associated with the can of pea soup. For example, user device UD1 may determine item information by scanning a barcode associated with the can of pea soup. As shown, the FoodMart mobile checkout application may display the item information on a display screen of user device UD1. The item information may indicate that one can of pea soup was scanned, may indicate that the retail cost of the can of pea soup is $2.00, may indicate that a $0.50 discount was automatically applied to the cost of the can of pea soup, and may indicate that a total cost of the can of pea soup is $1.50. The user of user device UD1 may indicate that the user is done scanning items and wishes to complete the purchase of the pea soup by clicking a “checkout” button, as shown.

As further shown in FIG. 7C, user device UD1 may provide the item information associated with the pea soup to a server device 220. As shown, server device 220 may receive the item information, and may complete the mobile payment associated with the can of pea soup. For example, server device 220 may store credit card information associated with user device UD1, and may provide the credit card information and information indicating the $1.50 total cost of the can of pea soup to FoodMart device 230. FoodMart device 230 may charge the credit card associated with user device UD1 for the $1.50 total cost of the can of pea soup, and may communicate with server device 220 to confirm that the $1.50 payment was approved. Server device 220 may determine checkout information associated with the can of pea soup based on the confirmation that the $1.50 payment was completed.

As shown in FIG. 7D, server device 220 may provide the checkout information to user device UD1 and FoodMart device 230. The checkout information may indicate that payment for the can of pea soup was approved. For example, server device 220 may provide the checkout information that may indicate that the $1.50 payment was approved, as shown. The checkout information may also indicate that a copy of the receipt for the can of pea soup has been saved to server device 220, as shown. The user of user device UD1 may conclude the transaction by clicking a “done” button, as shown.

As further shown in FIG. 7D, server device 220 may provide the checkout information to FoodMart device 230. For example, the checkout information provided to FoodMart device 230 may include a confirmation that the payment was made, and may include item information associated with the can of pea soup (e.g., for FoodMart inventory purposes, for FoodMart security purposes, etc.).

As shown in FIG. 7E, server device 220 may provide checkout information to a device associated with FoodMart (e.g., via FoodMart device 230) that may indicate that a security device associated with the can of pea soup may be disabled. For example, server device 220 may communicate with FoodMart device 230, which may disable a security tag attached to the can of pea soup. Alternatively, server device 220 may communicate with FoodMart device 230, and FoodMart device 230 may provide information, to a security device near the exit of FoodMart, indicating that a particular security tag (e.g., an NFC tag) attached to the pea soup is not to trigger a security alarm when the pea soup passes through the security device. As shown, the user of user device UD1 may pass through security scanners and exit FoodMart with the purchased can of pea soup.

As indicated above, FIGS. 7A-7E are provided merely as an example. Other examples are possible and may differ from what was described with regard to FIGS. 7A-7E.

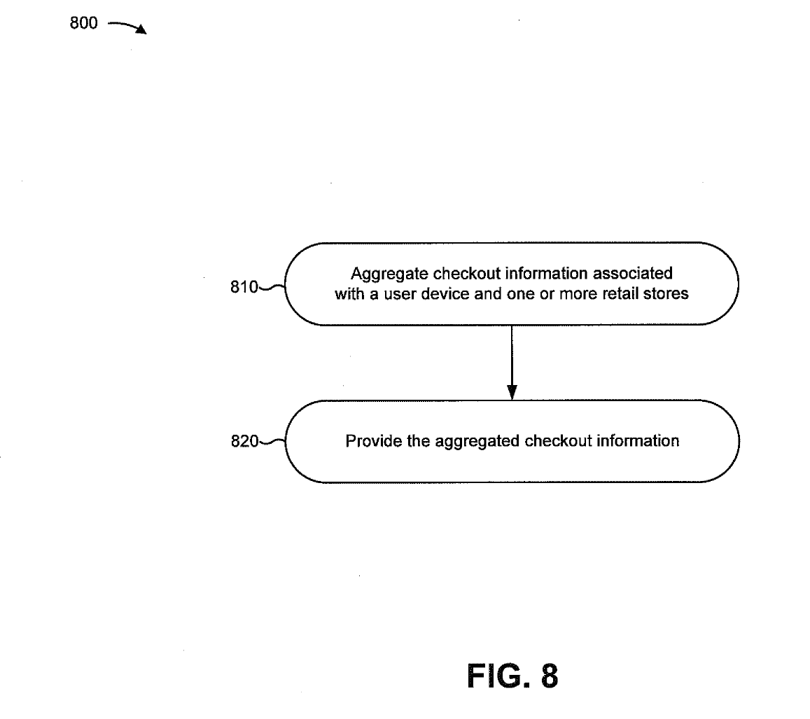

FIG. 8 is a flow chart of an example process 800 for aggregating checkout information and providing the aggregated checkout information. In some implementations, one or more process blocks of FIG. 8 may be performed by server device 220. In some implementations, one or more process blocks of FIG. 8 may be performed by another device or a group of devices separate from or including server device 220, such as user device 210 and/or retailer device 230.

As shown in FIG. 8, process 800 may include aggregating checkout information associated with a user device and one or more retail stores (block 810). For example, server device 220 may aggregate checkout information, associated with user device 210 and one or more retail stores, received from user device 210. In some implementations, server device 220 may aggregate checkout information based on a user device identifier (e.g., IMSI, MSISDN, MDN, etc.) associated with the checkout information. Additionally, or alternatively, server device 220 may aggregate the checkout information based on a user account (e.g., a username and password associated with the mobile checkout application, etc.) associated with the checkout information. Additionally, or alternatively, server device 220 may aggregate the checkout information based on the retail store associated with the checkout information (e.g., the retail store where an item was purchased). Additionally, or alternatively, server device 220 may aggregate the checkout information based on a category of the item associated with the checkout information (e.g., a food category, a clothing category, etc.). Additionally, or alternatively, server device 220 may aggregate checkout information based on a date of purchase associated with the checkout information (e.g., a day, a week, a month, etc.). Additionally, or alternatively, server device 220 may aggregate the checkout information based on a cost of the item associated with the checkout information (e.g., a cost over $20.00, a cost over $50.00, a cost between $20.00 and $50.00, etc.).

As further shown in FIG. 8, process 800 may include providing the aggregated checkout information (block 820). For example, server device 220 may provide the aggregated checkout information to retailer device 230. In some implementations, the aggregated checkout information may be used by a retail store for promotional purposes and/or inventory purposes. Additionally, or alternatively, server device 220 may provide the aggregated checkout information to user device 210. In some implementations, the aggregated checkout information may be used by the user of user device 210 for receipt review and/or financial planning purposes. In some implementations, the aggregated checkout information may allow a retail store to access checkout information associated with another retail store (e.g., the aggregated checkout information may be shared with one or more retail stores).

While a series of blocks has been described with regard to FIG. 8, the blocks and/or the order of the blocks may be modified in some implementations. Additionally, or alternatively, non-dependent blocks may be performed in parallel. Further, one or more blocks may be omitted.

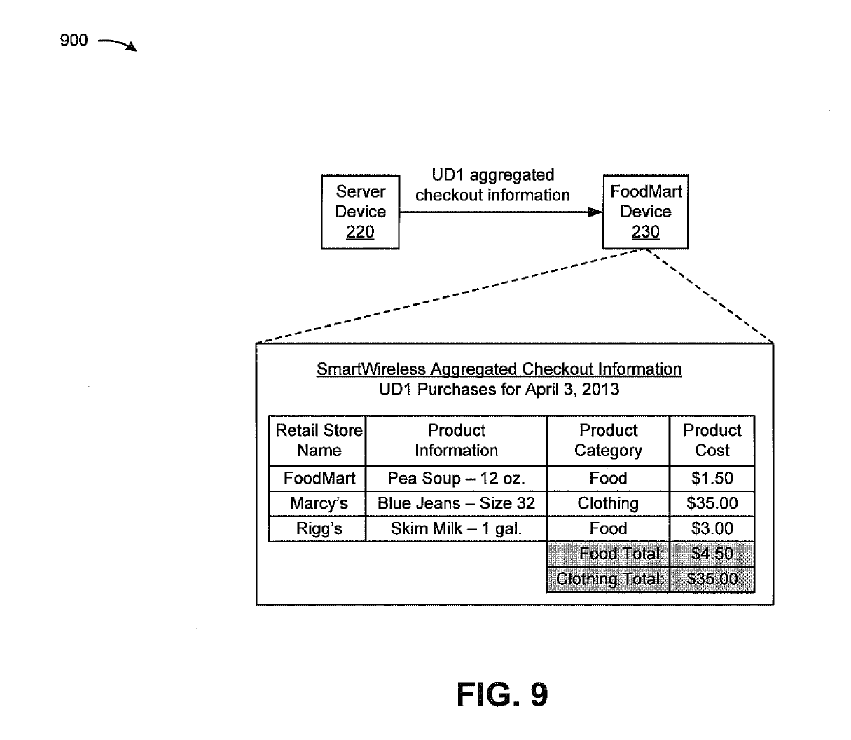

FIG. 9 is a diagram of an example implementation 900 relating to example process 800 shown in FIG. 8. In example implementation 900, assume that server device 220 provides aggregated checkout information, associated with user device UD1, to FoodMart device 230. As shown in FIG. 9, assume that server device 220 has stored checkout information associated with purchases made using a SmartWireless mobile checkout application installed on user device UD1. For example, server device 220 may store checkout information indicating that the SmartWireless mobile checkout application installed on user device UD1 was used on Apr. 3, 2013 to purchase a 12 ounce can of pea soup from FoodMart at a cost of $1.50, a pair of size 32 blue jeans from Marcy's at a cost of $35.00, and a gallon of skim milk from Rigg's at a cost of $3.00.

As shown in FIG. 9, server device 220 may aggregate the checkout information. For example, server device 220 may aggregate the checkout information for purchases made on Apr. 3, 2013 based on the category of the item purchased, as shown. As shown, server device 220 may aggregate a total cost of food purchases made on Apr. 3, 2013 as $4.50, and may aggregate a total cost of clothing purchases made on Apr. 3, 2013 as $35.00.

As further shown in FIG. 9, server device 220 may provide the aggregated checkout information to FoodMart device 230. FoodMart device 230 may store the aggregated checkout information and/or use the aggregated checkout information for another purpose (e.g., a promotional purpose, an inventory tracking purpose, etc.).

As indicated above, FIG. 9 is provided merely as an example. Other examples are possible and may differ from what was described with regard to FIG. 9.

Implementations described herein may allow a user of a user device to complete a purchase of one or more items from one or more retail stores using a triggered mobile checkout application, and the information associated with the purchases may be stored for future review and/or use by the user, the one or more retail stores, and/or the service provider. Additionally, implementations described herein may benefit a retail store by saving coupon printing and mailing costs, by directly communicating with a purchaser (e.g., by providing targeted content while the purchaser is in the retail store, etc.), by maximizing the use of real estate for product sales (e.g., by eliminating checkout lanes, etc.), by managing inventory, or the like.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Certain user interfaces have been described herein. In some implementations, the user interfaces may be customizable by a user or a device. Additionally, or alternatively, the user interfaces may be pre-configured to a standard configuration, a specific configuration based on a type of device on which the user interfaces are displayed, or a set of configurations based on capabilities and/or specifications associated with a device on which the user interfaces are displayed.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
determine that a user device has detected an event that triggers the user device to execute a mobile checkout application associated with a retail store;
provide, to the user device, information that identifies a promotion associated with an item at the retail store;
receive, from the user device, item information that identifies the item;
provide, to the user device, checkout information associated with purchasing the item,
the checkout information being based on the item information and the promotion;
store the checkout information associated with the retail store; and
store an association between the checkout information and other checkout information associated with the user device and another retail store.

2. The device of claim 1, where the one or more processors, when determining that the user device has detected the event that triggers the user device to execute the mobile checkout application, are further to:
determine that the user device has opted in to use the mobile checkout application; and
where the one or more processors, when providing the information that identifies the promotion associated with the item at the retail store, are further to:
provide the information based on determining that the user device is opted in to use the mobile checkout application.

3. The device of claim 1, where the one or more processors, when determining that the user device has detected the event, are further to:
determine content, associated with the retail store, identifying a customized user interface of the mobile checkout application; and
provide the content to the user device for display.

4. The device of claim 1, where the one or more processors, are further to:
provide, to a device associated with the retail store, profile information associated with a user of the user device,
the profile information including demographic information associated with the user or purchase history information associated with the user; and
receive, from the device associated with the retail store, information associated with a targeted promotional campaign based on providing the profile information;
where the one or more processors, when providing the information that identifies the promotion, are further to:
provide the information that identifies the promotion based on receiving the information associated with the targeted promotional campaign.

5. The device of claim 1, where the one or more processors are further to:
determine a method of payment, associated with the user device, for purchasing the item;
process a payment based on the method of payment, the item information, and the promotion; and
determine the checkout information based on processing the payment;
where the one or more processors, when providing the checkout information associated with purchasing the item, are further to:
provide the checkout information based on determining the checkout information.

6. The device of claim 1, where the one or more processors, when providing the checkout information, are further to:
provide the checkout information to a security device, associated with the retail store, to disable a security tag associated with the item.

7. The device of claim 1, where the one or more processors are further to:
aggregate the checkout information and the other checkout information to form aggregated checkout information; and
provide the aggregated checkout information to a device associated with the retail store or to a device associated with the other retail store.

8. A computer-readable medium storing instructions, the instructions comprising:
one or more instructions that, when executed by a processor, cause the processor to:
detect an event that triggers a user device to execute a mobile checkout application associated with a plurality of retailers;
receive information that identifies a retailer, of the plurality of retailers, associated with the event;
receive targeted promotional information associated with the retailer;
detect an item identifier that identifies an item to be purchased from the retailer;
receive information that identifies an association between the item identifier and the targeted promotional information; and
receive checkout information associated with purchasing the item,
the checkout information being based on the association between the item identifier and the targeted promotional information.

9. The computer-readable medium of claim 8, where the one or more instructions, that cause the processor to detect the event, further cause the processor to:
detect the event based on detecting a network identifier associated with the retailer; and
where the one or more instructions, that cause the processor to receive information that identifies the retailer, further cause the processor to:
receive information that identifies the retailer based on the network identifier associated with the retailer.

10. The computer-readable medium of claim 8, where the one or more instructions, that cause the processor to detect the event, further cause the processor to:
detect the event based on detecting input, from a user of the user device, identifying the retailer; and
where the one or more instructions, that cause the processor to receive information that identifies the retailer, further cause the processor to:
receive information identifying the retailer based on the input identifying the retailer.

11. The computer-readable medium of claim 8, where the one or more instructions, that cause the processor to detect the event, further cause the processor to:
detect a location of the user device;
determine a location of the retailer; and
detect the event based on determining that the user device is located within a particular distance of the retailer based on the location of the user device and the location of the retailer;
where the one or more instructions, that cause the processor to receive information that identifies the retailer, further cause the processor to:
receive information identifying the retailer based on determining that the user device is located within a particular distance of the retailer.

12. The computer-readable medium of claim 8, where the one or more instructions, that cause the processor to receive information that identifies the retailer associated with the event, further cause the processor to:
receive content, associated with the retailer, identifying a customized user interface of the mobile checkout application; and
present the customized user interface of the mobile checkout application for display.

13. The computer-readable medium of claim 8, where the item identifier includes at least one of:
a barcode identifying the item;
a near field communication tag identifying the item; or
a quick response code identifying the item.

14. The computer-readable medium of claim 8, where the one or more instructions further cause the processor to:
receive information associated with disabling a security tag of the item; and
transmit the information to a security device associated with the retailer to disable the security tag.

15. A method, comprising:
determining, by a device, that a user device has detected a trigger associated with a retail store;
providing, by the device, information that identifies a promotion associated with an item at the retail store based on determining that the user device has detected the trigger;
receiving, by the device, item information for a plurality of items associated with the retail store,
the plurality of items including the item;
determining, by the device, checkout information based on the item information and the promotion;
aggregating, by the device, checkout information and other checkout information associated with another retail store,
the other checkout information being associated with the user device; and
outputting or storing, by the device, the aggregated checkout information.

16. The method of claim 15, where determining that the user device has detected the trigger further comprises:
determining that the user device is within a threshold proximity of the retail store.

17. The method of claim 15, further comprising:
determining, based on determining that the user device has detected the trigger, content associated with the retail store,
the content identifying a customized user interface to be displayed by the user device; and
providing the content to the user device for display.

18. The method of claim 15, further comprising:
providing, to a device associated with the retail store, profile information associated with a user of the user device,
the profile information including demographic information associated with the user or purchase history information associated with the user; and
receiving, from the device associated with the retail store, information associated with a targeted promotional campaign based on providing the profile information;
where providing the information that identifies the promotion further comprises:
providing the information that identifies the promotion based on receiving the information associated with the targeted promotional campaign.

19. The method of claim 15, further comprising:
determining a method of payment, associated with the user device, for purchasing the item; and
processing a payment based on the method of payment, the item information, and the promotion;
where determining the checkout information further comprises:
determining the checkout information based on processing the payment.

20. The method of claim 15, further comprising:
providing, based on determining the checkout information, an indication to a security device associated with the retail store,
the indication indicating that the security device is to disable a security tag associated with the item.
